(19) United States
(12) Patent Application Publication
(10) Pub. No.: US 2003/0049385 A1
(43) Pub. Date: Mar. 13, 2003

(54) Lubricator for rubber gaskets of PVC and other pipe

(76) Inventor: Corey G. Barnes, Bellvue, CO (US)

Correspondence Address: Richard C. Litman, LITMAN LAW OFFICES, LTD., P.O. Box 15035, Arlington, VA, 22215, US

(21) Appl. No.: 10/233,579

(22) Filed: Sep. 4, 2002

Related U.S. Application Data
(60) Provisional application No. 60/317,957, filed on Sep. 10, 2001.

(51) Int. Cl. B05D 1/28

(52) U.S. Cl. 427/428

(57) ABSTRACT

A device especially designed to apply lubricant to the gaskets of PVC or other type pipes. The lubricating device includes a “paint-type” roller which is rotatably mounted on an extended handle. Unlike paint rollers, the roller of the instant device is rotatable around a longitudinal axis which is coaxial with the longitudinal axis of the handle.

### CROSS-REFERENCE TO RELATED APPLICATION

This application claims the benefit of U.S. Provisional Patent Application Serial No. 60/317,957, filed Sep. 10, 2001.

### BACKGROUND OF THE INVENTION

1. Field of the Invention

The present invention generally relates to coating devices. More specifically, the present invention is drawn to a device for applying lubricant to the gaskets of PVC pipes and the like.

2. Description of Related Art

The installation of PVC, ductile, iron and other pipe having rubber seating gaskets requires lubrication of the gasket at the female end of a pipe to enhance insertion of the male end of an adjoining pipe. The prevailing industry standard is that the lubricant is applied by using a rag, old glove or paint brush. The prior named application devices have proven to be cumbersome and inefficient. An inexpensive, easy-to-use, effective device for the application of lubricant to the gaskets of pipes would certainly be a welcome addition to the art.

The prior art, as exemplified in U.S. Pat. No. 27,438 (Ferguson) shows a rod and piston device utilized to blackwash pipe molds. The rod must be disengaged from the piston before the device can be reused and there is no rotary motion for even application of the wash.

U.S. Pat. No. 360,746 (Weindel) discloses apparatus for gluing kegs and barrels, which device also incorporates rotary bristles for cleaning. The instant device requires relatively expensive, complicated mechanisms for operation.

U.S. Pat. No 2,158,579 (Hodgkins et al.) is drawn to an apparatus for painting pipe lines. The apparatus includes a weighty motor for pumping the painting medium and rotating a brush.

U.S. Pat. No. 2,547,091 (Peffer) shows a brush and spindle construction for cleaning and greasing pans. The construction requires an extensive and relatively complicated spindle design.

U.S. Pat. No. 2,629,121 (Petre) discloses a rotatable brushing tool for cleaning pipe threads. The frusto-conical configuration of the brush body would not be efficient if utilized to apply an even coat of lubricant.

U.S. Pat. No. 3,394,025 (McCune) shows a device which includes a plurality of barrier and slide members for coating the interior of a pipe. The device is relatively complicated to assemble and use.

None of the above inventions and patents, taken either singly or in combination, is seen to disclose a device for lubricating the rubber gaskets of pipes as will subsequently be described and claimed in the instant invention.

### SUMMARY OF THE INVENTION

The present invention is a device especially designed to apply lubricant to the gaskets of PVC or other type pipes. The lubricating device includes a “paint-type” roller which is rotatably mounted on an extended handle. Unlike paint rollers, the roller of the instant device is rotatable around a longitudinal axis which is coaxial with the longitudinal axis of the handle. In use, lubricant is applied to the roller in any convenient manner (dipping, pouring, etc.). The roller is then inserted into the female end of a pipe to contact the gasket therein. The roller is rolled around the gasket to evenly apply lubricant to the gasket's surfaces. The male end of an adjoining pipe may now be efficiently inserted into the female end without damaging the gasket. The roller may be easily replaced if soiled or damaged. The device may be utilized for sewer pipe, water pipe or almost any pipe installation project. The device may be color-coded to distinguish between sewer and potable water use.

Accordingly, it is a principal object of the invention to provide a tool for enhancing the lubrication of pipe gaskets.

It is another object of the invention to provide a tool for lubricating pipe gaskets, which tool efficiently applies lubricant evenly on the surfaces of pipe gaskets.

It is a further object of the invention to provide a tool for lubricating pipe gaskets, which tool is easy to use.

Still another object of the invention is to provide a tool for lubricating pipe gaskets in which the lubricant applicator may be easily replaced if soiled or damaged.

It is an object of the invention to provide improved elements and arrangements thereof in a tool for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1 is an environmental, perspective view of a lubricating tool for rubber gaskets of PVC and other pipe according to the present invention.

FIG. 2 is an exploded view of a lubricating tool for rubber gaskets of PVC and other pipe according to the present invention.

Similar reference characters denote corresponding features consistently throughout the attached drawings.

### DETAILED DESCRIPTION OF THE PREFERRED EMBODIMENT

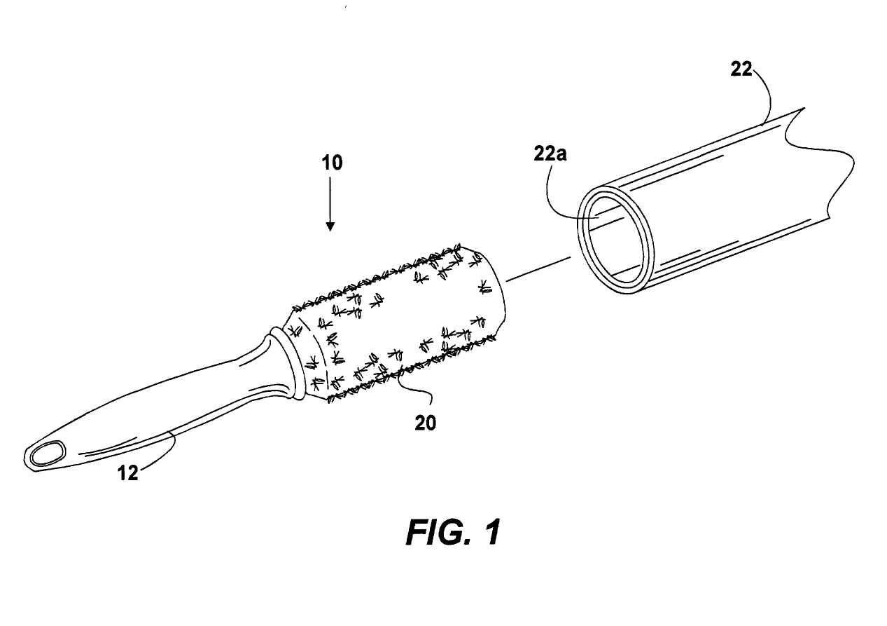

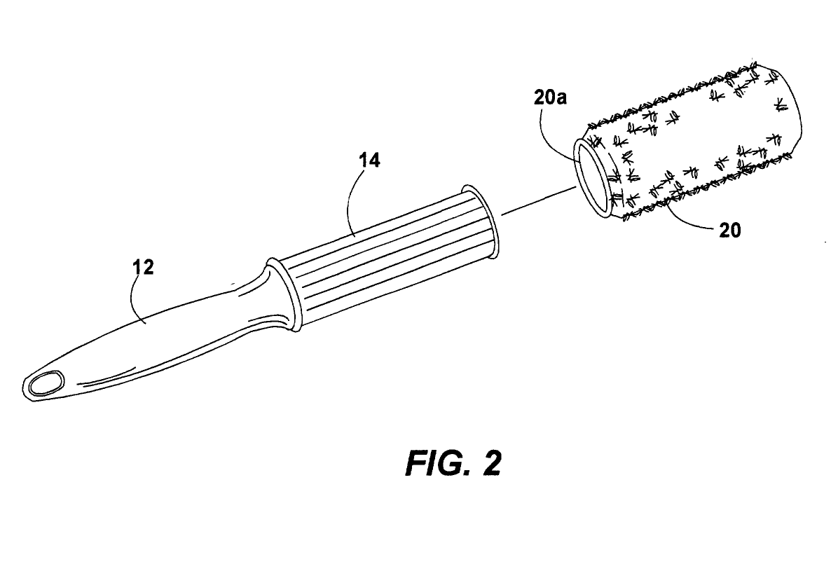

The lubricating tool of the present invention is generally indicated at 10 in FIGS. 1 and 2. Tool 10 comprises a handle 12 which may be fabricated from metallic, plastic or wood material. Handle 12 is sculpted so as to be ergonomic.

As best seen in FIG. 2, handle 12 is provided with a an extended cylindrical portion 14, which portion is coaxial with the longitudinal axis of the handle. As contemplated, handle 12 and portion 14 are fabricated as a one-piece structure.

A paint-type roller 20 is adapted to be supported on cylindrical portion 14 and rotatable thereon. Roller 20 is mounted on a plastic tube 20a and may be fabricated from any water-resistant nap material (synthetic or natural) which will absorb and hold pipe lubricant. As with paint rollers, roller 20 may be easily mounted and removed from portion 14.

As discussed above and depicted in FIG. 1, a lubricant-ladened roller 20 is inserted in the end of a pipe 22 and is rolled therein so as to easily and efficiently apply lubricant to pipe gasket 22a. In most sewer and water pipe installations, a handle length and diameter of about six inches and one-quarter inch respectively and a roller length and outside diameter of about four inches and two inches respectively have been found to be sufficient. The cylindrical portion 14 is also about four inches in length. These dimensions make for a small tool which may be conveniently carried. It is recognized that the tool may be fabricated in larger or smaller dimensions for specialized jobs.

It is to be understood that the present invention is not limited to the sole embodiment described above, but encompasses any and all embodiments within the scope of the following claims.

We claim:

1. A lubricating tool comprising:
a handle, said handle having a longitudinal axis;
a cylindrical member extending from said handle and coaxial with said longitudinal axis;
a lubricant absorbing body removably mounted on said cylindrical member and rotatable thereon.

2. A lubricating tool as recited in claim 1, wherein said handle and said cylindrical member are fabricated as a one-piece structure.

3. A lubricating tool as recited in claim 2, wherein said handle has a length of approximately four inches.

4. A lubricating tool as recited in claim 3, wherein said cylindrical member has a length of approximately four inches.

5. A lubricating tool as recited in claim 4, wherein said lubricant absorbing body comprises a plastic tube having a water-resistant, lubricant-absorbing, nap material mounted thereon.

6. A lubricating tool according to claim 5, wherein said nap material is fabricated from a natural material.

7. A lubricating tool according to claim 5, wherein said nap material is fabricated from a synthetic material.

8. A lubricating tool comprising:
a handle, said handle having a length of approximately four inches and a longitudinal axis;
a cylindrical member extending from said handle and coaxial with said longitudinal axis, said cylindrical member having a length of approximately four inches; and
a lubricant absorbing body removably mounted on said cylindrical member and rotatable thereon.
